(19) United States
(12) Patent Application Publication
(10) Pub. No.: US 2018/0148119 A1
(43) Pub. Date: May 31, 2018

(54) LEAN STEERED VEHICLE

(71) Applicant: Jacqueline Kay HART, Hamilton (NZ)

(72) Inventor: Barry MULDER, Hamilton (NZ)

(21) Appl. No.: 15/580,745

(22) PCT Filed: Jun. 10, 2016
(86) PCT No.: PCT/NZ2016/050095

§ 371 Date: Dec. 8, 2017

(30) Foreign Application Priority Data
Jun. 10, 2015 (NZ) 708993

(51) Int. Cl. B62K 5/10; B62K 5/08; B62K 27/12

(52) U.S. Cl. CPC B62K 5/10; B62K 2005/002; B62K 27/12; B62K 5/08

(57) ABSTRACT

Golf carts are typically large and relatively heavy vehicles that either needs to be stored at the golf course, or to be transported home or to another golf course on a trailer. This adds cost and complexity to the use of a golf cart. And since golf carts are often used by people with limited physical strength, the handling problems become more significant. The disclosed vehicle minimizes these problems by providing a relatively simple and light weight vehicle that can be operated on golf courses, and which can be disassembled to fit into the back of a car, or can be mounted on a tow bar. The vehicle is lightweight, stable on golfing fairways and is simple to steer, due to an innovative lean steering system, in which the body of the vehicle is able to pivot in a controlled manner relative to both a front and a rear axle.

### FIELD OF THE INVENTION

This invention relates to lean steered vehicles, and in particular, but not exclusively to a lean steered vehicle for sport or recreational uses or for mobility purposes.

### BACKGROUND

There are a number of applications for light weight or low cost vehicles, for example for use as mobility scooters, golf carts or sporting vehicles. In these applications it can be useful if the vehicles are light enough to allow them to be manoeuvred by hand, or to be transported without difficulty.

Golf carts are a classic example. They need to be stable vehicles that can negotiate the terrain of a golf course and must have sufficient range to get around an entire course. And at the same time, it is helpful if they can be transported easily, for example to allow them to be transported between home and the gold course, or between different golf courses.

Mobility scooters have similar requirements. They need to be large enough to provide stability and to have sufficient range, but must be light enough that they can be easily manoeuvred when required for storage or when being transported to a new location.

Sporting vehicles have a wide range of requirements, but often weight and maneuverability are important considerations. The heavier a vehicle the more power is required, and the larger the engine size the greater the requirement for fuel or battery capacity.

Vehicle chassis design and construction, and steering design and componentry, are factors that can add to the weight and complexity of a vehicle.

Lean steered vehicles provide a solution to some of these issues, and provide a relatively light weight and simple vehicle chassis and steering system configuration. However, the design of lean steered vehicles is still relatively new, and lean steered vehicles often experience difficulty in either the area of stability or maneuverability. It has often seemed difficult to reconcile these conflicting requirements and to produce a light weight, and simple, yet maneuverable and at the same time relatively stable and controllable, vehicle.

In this specification unless the contrary is expressly stated, where a document, act or item of knowledge is referred to or discussed, this reference or discussion is not an admission that the document, act or item of knowledge or any combination thereof was at the priority date, publicly available, known to the public, part of common general knowledge; or known to be relevant to an attempt to solve any problem with which this specification is concerned.

### OBJECT

It is therefore an object of the present invention to provide a lean steered vehicle which will at least go some way towards overcoming one or more of the above mentioned problems, or at least provide the public with a useful choice.

### STATEMENTS OF THE INVENTION

Accordingly, in a first aspect, the invention may broadly be said to consist in a lean steered vehicle, the vehicle having a vehicle chassis, and the vehicle chassis having a forward chassis member, an aft chassis member, and a longitudinal chassis member which is connected to the forward chassis member by a forward pivotal connection which is located at or adjacent a forward end of the longitudinal chassis member, and which is connected to the aft chassis member by an aft pivotal connection which is located at or adjacent an aft end of the longitudinal chassis member, and the longitudinal chassis member is configured to support at least one vehicle occupant, and the angle between the forward chassis member and the longitudinal chassis member, and between the aft chassis member and the longitudinal chassis member, are both controlled by rotating the longitudinal chassis member about a rotational axis.

Preferably the rotational axis lies substantially within a vertical plane which is aligned with a longitudinal axis of the vehicle.

Preferably the vehicle includes a seat and hand engagement means.

Preferably the hand engagement means include handlebars and hand grips.

Preferably the hand engagement means are supported by the aft chassis member.

Optionally the hand engagement means are supported on levers which are used to alter the aft chassis member and the longitudinal member.

Preferably the vehicle includes foot engagement means.

Preferably the foot engagement means include pedals.

Preferably the foot engagement means are supported on levers which are used to alter the angle between the forward chassis member and the longitudinal member.

The vehicle could include water engagement means, for example a forward hull or hulls, and an aft hull or hulls, however, preferably the vehicle includes ground engagement means.

The forward and/or aft ground engagement means could include skids, skis or tracks, however, preferably the forward and/or aft ground engagement means include wheels.

Preferably the vehicle includes four wheels.

Preferably the pivotal connection between the forward chassis member and the longitudinal chassis member is a connection configured to pivot about an axis which lies within a substantially vertical plane which intersects a longitudinal axis of the vehicle, when the vehicle is situated on level ground and the ground or water engagement means are configured for straight travel.

Preferably the rotational axis is an axis which passes substantially through both the forward pivotal connection and the aft pivotal connection.

Preferably the forward pivotal connection facilitates rotation about a forward pivotal axis which lies at an angle in the range of thirty to eighty five degrees to the rotational axis.

More preferably the forward pivotal connection facilitates rotation about a forward pivotal axis which lies at an angle in the range of fifty to seventy degrees to the rotational axis.

Preferably the aft pivotal connection facilitates rotation about an aft pivotal axis which lies at an angle in the range of zero to forty degrees to the rotational axis.

More preferably the aft pivotal connection facilitates rotation about an aft pivotal axis which lies at an angle in the range of thirteen to twenty three degrees to the rotational axis.

Preferably the rotational axis lies at an angle in the range of ten to thirty degrees to a horizontal plane when the vehicle is situated on level ground.

Optionally the pivotal connection between the forward chassis member and the longitudinal chassis member is a connection configured to pivot about an axis which is at an angle of between twenty and fifty degrees to a horizontal plane when the vehicle is situated on level ground.

Optionally the pivotal connection between the forward chassis member and the longitudinal chassis member is a connection configured to pivot about an axis which is at an angle of between thirty and forty degrees to a horizontal plane when the vehicle is situated on level ground.

Optionally the pivotal connection between the aft chassis member and the longitudinal chassis member is a connection configured to pivot about an axis which lies within a substantially vertical plane which intersects a longitudinal axis of the vehicle, when the vehicle is situated on level ground and the ground or water engagement means are configured for straight travel.

Optionally the pivotal connection between the aft chassis member and the longitudinal chassis member is a connection configured to pivot about an axis which is at an angle of between twenty and fifty degrees to a horizontal plane when the vehicle is situated on level ground.

Optionally the pivotal connection between the aft chassis member and the longitudinal chassis member is a connection configured to pivot about an axis which is at an angle of between thirty and forty degrees to a horizontal plane when the vehicle is situated on level ground.

Preferably the vehicle includes self righting means configured to return the aft chassis member and/or the forward chassis member to a neutral or ‘straight ahead’ configuration after any lean steering manoeuvre is used to steer the vehicle to the left or to the right.

Preferably the vehicle includes a suspension system between the aft and/or the forward chassis member and the ground or water engagement means.

In a second aspect, the invention may broadly be said to consist in a vehicle on vehicle mounting system having a receiving member configured to receive and secure a part of a first vehicle, and having a towbar engagement means configured to engage with a towbar of a second vehicle, and wherein the vehicle on vehicle mounting system also includes a hinge and is configured to allow the first vehicle to be supported by the towbar of the second vehicle, and to allow the first vehicle be lifted about the hinge to a position substantially above the towbar of a second vehicle.

Preferably the towbar engagement means includes a clamp configured to hold the mounting system firmly onto a vehicle towball.

Preferably the receiving member includes a sleeve adapted to receive a structural member of the first vehicle.

Preferably the vehicle on vehicle mounting system further includes a locking means configured to hold the first vehicle in the position substantially above the towbar of a second vehicle.

Preferably the locking means is also configured to hold the first vehicle within the receiving member.

In a third aspect, the invention may broadly be said to consist in a lean steered vehicle incorporating at least one vehicle on vehicle mounting system substantially as specified herein.

The invention may also broadly be said to consist in the parts, elements and features referred to or indicated in the specification of the application, individually or collectively, and any or all combinations of any two or more of the parts, elements or features, and where specific integers are mentioned herein which have known equivalents, such equivalents are incorporated herein as if they were individually set forth.

### DESCRIPTION

Further aspects of the present invention will become apparent from the following description which is given by way of example only and with reference to the accompanying drawings in which:

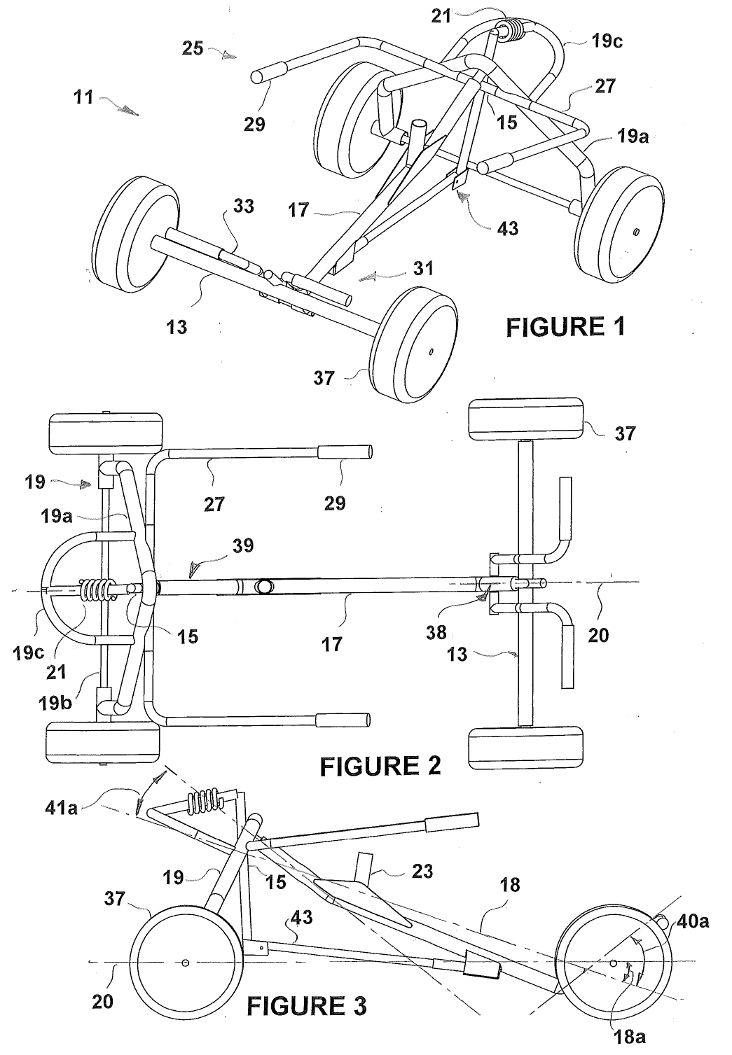

FIG. 1 is a perspective view of a lean steered vehicle,

FIG. 2 is a plan view of the lean steered vehicle,

FIG. 3 is a side elevation view of the lean steered vehicle,

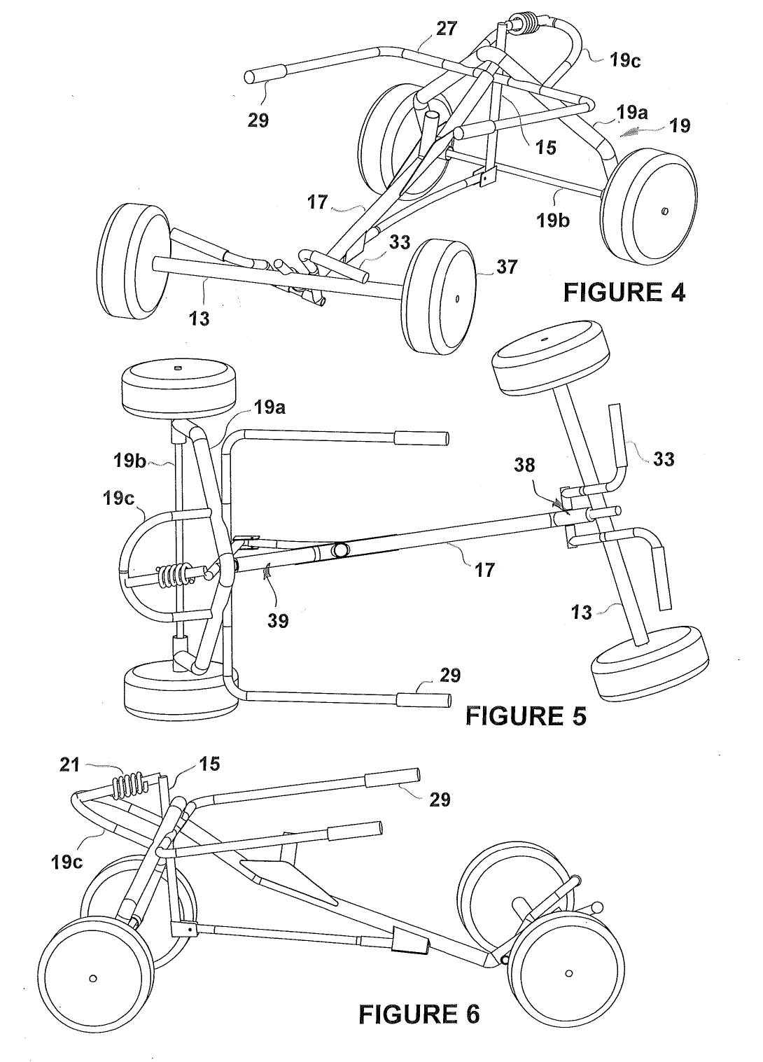

FIG. 4 is a perspective view of a lean steered vehicle in a left turn configuration,

FIG. 5 is a plan view of the lean steered vehicle in a left turn configuration,

FIG. 6 is a side elevation view of the lean steered vehicle in a left turn configuration,

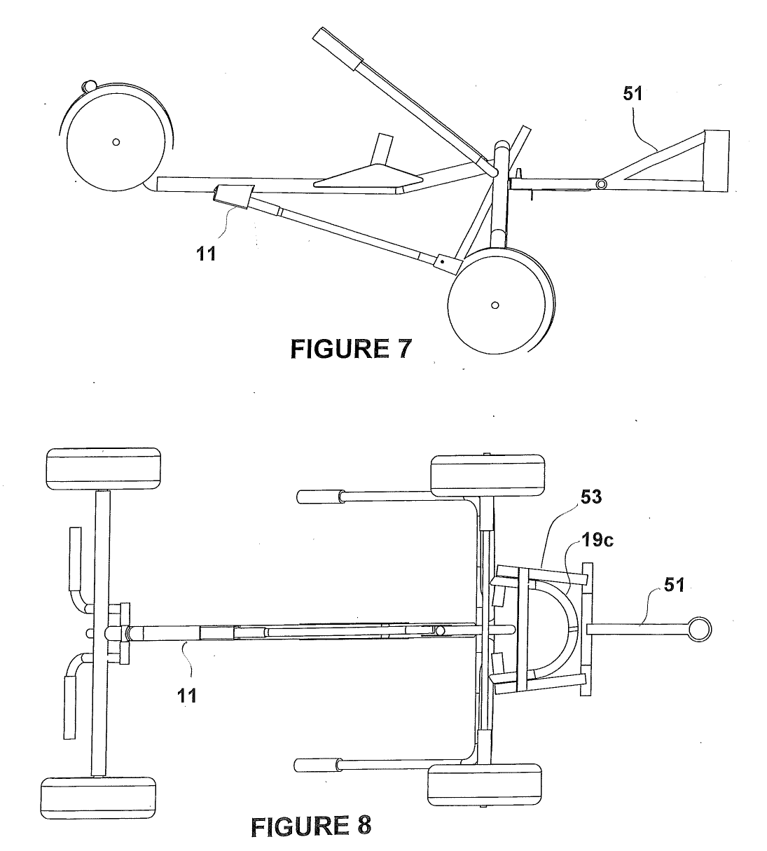

FIG. 7 is a side elevation view showing a vehicle on vehicle mounting system with the lean steered vehicle fitted to it,

FIG. 8 is a bottom plan elevation view showing the vehicle on vehicle mounting system with the lean steered vehicle fitted to it,

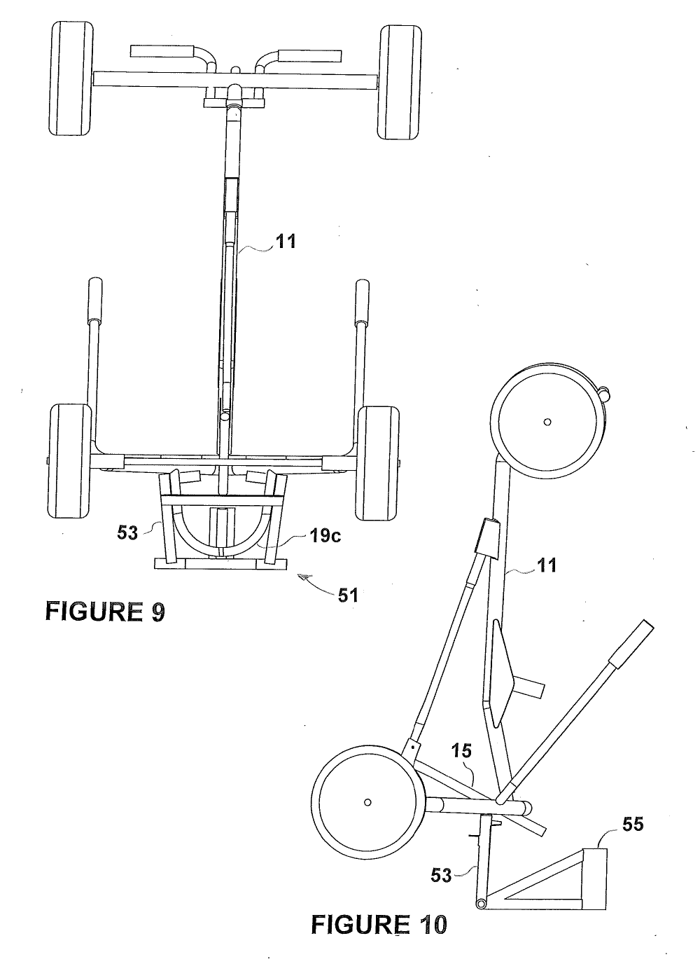

FIG. 9 is an end elevation view showing the vehicle on vehicle mounting system with the lean steered vehicle raised to a vertical position,

FIG. 10 is a side elevation view showing the vehicle on vehicle mounting system with the lean steered vehicle raised to the vertical position,

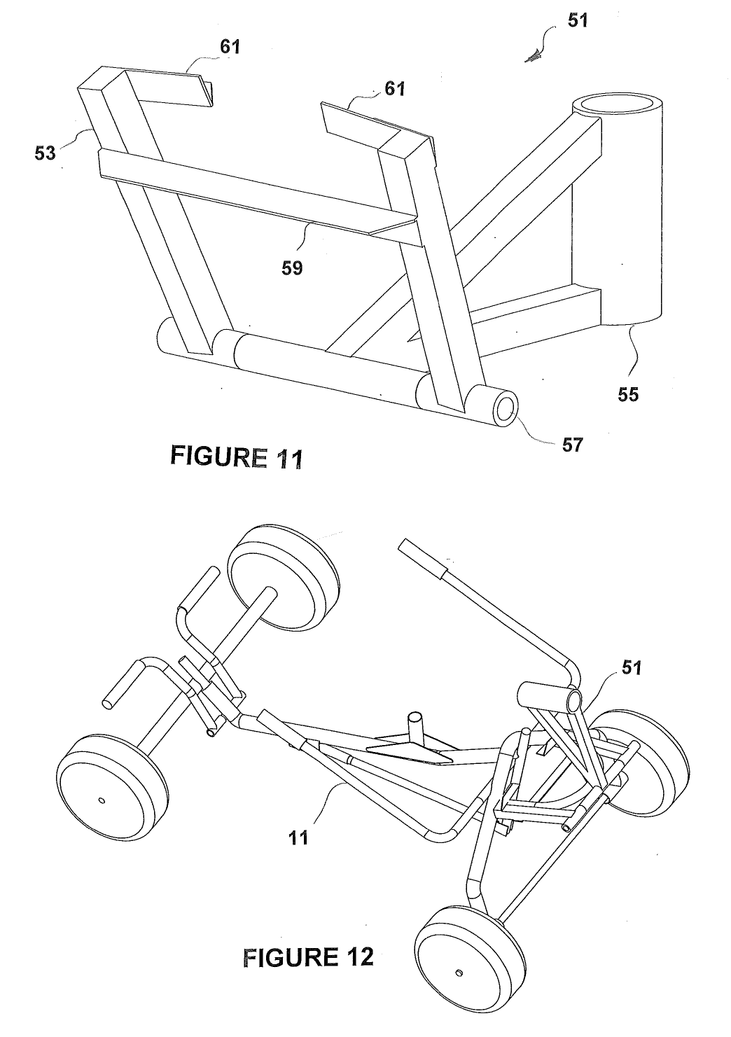

FIG. 11 is a perspective view of the vehicle on vehicle mounting system, and

FIG. 12 is a perspective view showing the vehicle on vehicle mounting system with the lean steered vehicle raised to the vertical position.

With reference to FIGS. 1 to 6, a lean steered vehicle (11) according to the present invention will now be described. The lean steered vehicle (11) has been designed to be simple and light weight in construction and suitable for applications such as a golf cart.

One of the important aspects driving the design of the vehicle is a desire to be able to transport the vehicle easily using a car or SUV. For this reason, the vehicle (11) has also been designed to engage with a vehicle on vehicle mounting system which will be explained with reference to FIGS. 7 to 11 below. The vehicle on vehicle mounting system allows the vehicle to be mounted onto the towbar of a car or SUV, and has been designed to be simple and easy to use.

The combination of the lightweight and versatile lean steered vehicle (11), and the simple vehicle on vehicle mounting system means that the vehicle can be moved easily to a golf course where it is to be used, and back home for storage.

The lean steered vehicle (11) has a vehicle chassis that is made up of a forward chassis member (13), an aft chassis member (15), and a longitudinal chassis member (17). A rear axle assembly (19) is pivotally mounted to the aft chassis member (15), and a sprung shock absorber (21) provides a suspension system for the rear of the vehicle (11).

A seat (not shown) to support a vehicle occupant is fitted to a tubular fitting (23) on the longitudinal chassis member (17).

The longitudinal chassis member (17) is pivotally connected to the forward chassis member (13) at a forward pivotal connection (38) at a forward end of the longitudinal chassis member (13). In this example, forward chassis member (13) is in the form of a simple tubular front axle member. The longitudinal chassis member (17) is also pivotally connected to the aft chassis member (15) at an aft pivotal connection (39) at an aft end of the longitudinal chassis member (15).

To facilitate steering, the angle between the forward chassis member or axle (13) and the longitudinal chassis member (17), and between the aft chassis member (15) and the longitudinal chassis member (17), are both controlled by rotating the longitudinal chassis member (17) about a rotational axis (18). In this example, the rotational axis (18) lies substantially within a vertical plane which is aligned with a longitudinal axis (20) of the vehicle (11).

While the rotational axis (18) can be aligned with the longitudinal axis (20), in this example the rotational axis (18) lies at an angle (18a) of approximately twenty degrees to the longitudinal axis (20), sloping upwards towards the rear of the vehicle (11).

The vehicle also includes hand engagement means (25) in the form of handlebars (27) and hand grips (29) which are supported from the aft chassis member (15).

In this example, the aft chassis member (15) is in the form of a “t” shaped member. The handlebars (27) extend from each of the horizontal arms of the “t” shaped member. In fact, both the left and right handlebars (27) are rigidly connected to a rod that is mounted within, and which passes through, the horizontal arms of the “t” shaped member. And furthermore, a clamping system is included in the horizontal arms of the “t” shaped member which allows the handlebars to be raised or lowered, with the rod rotating within the clamping system of the horizontal arms. The clamping system can be used to fix the handle bars at a particular angle or height, or the clamping system can be used to apply a desired level of resistance to rotation of the rod that allows the handlebars to be physically pushed up or down to assist with getting on or off the vehicle, or to suit a rider's preference, while still being fixed rigidly enough to keep the handlebars at any desired angle for use when riding the vehicle.

The rear axle assembly (19) comprises an “A” frame member (19a), an axle (19b), and a “C” shaped member (19c). The axle (19b) runs within bearings situated at the lower ends of the two legs of the “A” frame member (19a). The “C” shaped member (19c) is connected to each of the legs of the “A” frame member (19a) and extends in an aft direction, and in a plane that is perpendicular to that of the “A” frame member (19a).

The shock absorber (21) is connected at one end to the top of the vertical portion of the “t” shaped member of the aft chassis member (15), and is connected at its other end to an aft-most point of the “C” shaped member (19c) of the rear axle assembly (19).

The vehicle (11) also includes foot engagement means (31) which in this case includes pedals (33). The pedals (33) are supported on levers (35) which are used to alter the angle between the forward chassis member (13) and the longitudinal member (17). The pedals (33) are pivotally connected to the front end of the longitudinal member (17), and they are positioned in such a way that when either of the pedals (33) is pushed, the corresponding lever (35) bears against the front axle (13) and causes it to rotate a small amount relative to the longitudinal member (17).

In this example, the vehicle (11) includes ground engagement means in the form of four wheels (37).

As noted above, the forward chassis member (13) is connected to the longitudinal chassis member (17) via the forward pivotal connection (38). Similarly, the aft chassis member (115) is connected to the longitudinal chassis member (17) via the aft pivotal connection (39). The rotational axis (18) is an axis which passes substantially through both the forward pivotal connection (38) and the aft pivotal connection (39).

The forward pivotal connection (38) facilitates rotation of the longitudinal chassis member (17) about a forward pivotal axis (40) which lies at an angle (40a) of approximately sixty degrees to the rotational axis (18).

The aft pivotal connection (39) facilitates rotation of the longitudinal chassis member (17) about an aft pivotal axis (41) which lies at an angle (41a) of approximately eighteen degrees to the rotational axis (18).

In this example, the forward pivotal connection (38) is a pivotal connection about an axis which is at an angle of approximately thirty five degrees to a horizontal plane when the vehicle (11) is situated on level ground. While the angle of thirty five degrees has been used, it is envisaged that any angle between twenty and fifty degrees could be used, but preferably an angle between thirty and forty degrees. Also, the pivotal connection pivots about an axis which lies within a substantially vertical plane which intersects a longitudinal axis of the vehicle (11), when the vehicle (11) is situated on level ground and the wheels (37) are configured for straight travel.

In this example, the aft pivotal connection (39) is a pivotal connection about an axis which is at an angle of approximately thirty five degrees to a horizontal plane when the vehicle (11) is situated on level ground. Again, while the angle of thirty five degrees has been used, it is envisaged that any angle between twenty and fifty degrees could be used, but preferably an angle between thirty and forty degrees. Also, the pivotal connection pivots about an axis which lies within a substantially vertical plane which intersects a longitudinal axis of the vehicle (11), when the vehicle (11) is situated on level ground and the wheels (37) are configured for straight travel.

The vehicle (11) is steered by simply moving body weight to one side to rotate the longitudinal chassis member (17) about the rotational axis (18). The configuration of the pivot joints means that when the longitudinal chassis member (17) is rotated, the forward and aft chassis members (13) and (15) are turned as shown in FIGS. 4-6 to produce a steering input to the left or to the right.

To assist this steering action the pedals (33) can be pushed using the feet, and the hand grips (29) can be used to assist in shifting body weight and/or in twisting the longitudinal chassis member (17). In this way, steering is produced in a very intuitive manner using a simple and coordinated movement of the body, helped with the arms, and further assisted by a natural extension of the leg at the outside of the corner.

The vehicle (11) also includes self righting means (43) configured to return the aft chassis member (15) to return to a neutral or ‘straight ahead’ configuration after any lean steering manoeuvre is used to steer the vehicle (11) to the left or to the right. In this example, the self righting means (43) is in the form of a torsion rod that is connected at its forward end to the longitudinal chassis member (17) and at its aft end to the lower part of the vertical portion of the “t” shaped member of the aft chassis member (15). The torsion rod is a fibreglass rod and is bent and twisted as the angle between the longitudinal chassis member (17) and the aft chassis member (15) changes during a steering input.

The amount of resistance to turning, or the ‘self righting’ moment, provided by the torsion rod can be adjusted connecting it at differing locations up or down the lower part of the vertical portion of the “t” shaped member of the aft chassis member (15). The lower the connection point, the greater the resistance to turning, or the greater the self righting moment provided by the self righting means (43). The higher connection points are more suitable for a lighter passenger, while the lower connection points are more suitable for a heavier passenger.

It is envisaged that the self righting means (43) disclosed here could also be suitable for other vehicles, for example trikes that incorporate lean steering.

The vehicle has been shown without a motor or drive system. Although not shown, the vehicle preferably includes a battery pack, an electric motor and a drive system for example a chain drive system driving the rear axle. A hand operated controller mounted on one of the hand grips can be used to control forward motion and speed. Similarly, the vehicle can include brakes, for example disc brakes mounted on the forward or aft wheels and controlled by hand levers mounted adjacent to the hand grips.

With reference to FIGS. 7 to 11, the vehicle on vehicle mounting system (51) will now be described. The vehicle on vehicle mounting system (51) is primarily a fitting having a receiving member (53) and a tow bar engagement socket. The receiving member (53) acts like a sleeve or a socket and is configured to receive and secure a structural member of a first vehicle (in this example, the lean steer vehicle (11)).

The vehicle on vehicle mounting system (51) also includes a towbar engagement means (55) configured to engage with a towbar of a second vehicle, the second vehicle being a car or SUV for example that is used to transport the lean steer vehicle (11) about.

The vehicle on vehicle mounting system (51) also includes a hinge (57) between receiving member (53) and the towbar engagement means (55). This allows the first vehicle to be engaged into the receiving member (53) while it is aligned substantially horizontally, and allows the first vehicle be lifted about the hinge (57) to a position substantially above the towbar of a second vehicle. In this way, the first vehicle can be supported by, and above, the towbar of the second vehicle.

In this example, the “C” shaped member (19c) which forms a part of the rear axle assembly (19) is configured to fit within the receiving member (53). The “C” shaped member (19c) fits between a lower transverse member (59) and two upper transverse members (61) that are part of the receiving member (53). In this way, the lean steer vehicle (11) can be captured by the vehicle on vehicle mounting system (51) by backing the vehicle into the receiving member (53) as shown in FIGS. 7 and 8. And then the front end of the lean steer vehicle (11) can be lifted as shown in FIGS. 9, 10 and 12. When the first vehicle (11) is lifted in this way, it is supported by the tow bar of the second vehicle and can be transported by it with ease. And when the destination is reached, the first vehicle can be lowered to the ground again and can be disconnected from the receiving member (53).

The towbar engagement (55) means includes a clamp (not shown) that is configured to hold the mounting system (51) firmly onto a vehicle towball.

The vehicle on vehicle mounting system can further include a locking means (not shown) configured to hold the first vehicle in the position substantially above the towbar of a second vehicle, for example a stay bar which connects between the sleeve or the first vehicle and the towbar engagement means (55). The locking means can also be configured to hold the first vehicle within the receiving member (53).

Note: in FIGS. 7, 8, 9, 10 and 12 the shock absorber (21) of the lean steer vehicle (11) has been omitted for improved clarity of the drawings which are intended to show the features of the vehicle on vehicle mounting system (51).

The lean steer vehicle (11) has been designed to be light-weight, maneuverable and stable, but it is also important to note that it can be motorized with ease, and it can also include brakes. For example, an electric motor can be mounted to the A Frame (19a) and be used to drive the rear axle via a chain, belt or similar transmission system. A battery pack can also be mounted to the A Frame (19a) or to the vehicle chassis. Alternatively a petrol engine could be used to drive the vehicle. Similarly, a disc brake mechanism could be mounted on the rear axle and be operated by hand levers mounted adjacent to the hand grips.

### VARIATIONS

To those skilled in the art to which the invention relates, many changes in construction and widely differing embodiments and applications of the invention will suggest themselves without departing from the scope of the invention as defined in the appended claims. The disclosures and the description herein are purely illustrative and are not intended to be in any sense limiting.

In the example described above, the rotational axis (18) lies at an angle of approximately twenty degrees to the longitudinal axis (20). It is envisaged that the rotational axis (18) could lie at any angle to the longitudinal axis (20) within the range of zero to forty degrees, and preferably within the range of ten and thirty degrees.

In the example described above, the forward pivotal axis (40) lies at an angle of approximately sixty degrees to the rotational axis (18). The forward pivotal axis (40) can lie at a range of angles to the rotational axis (18), for example an angle within the range of thirty to eighty five degrees to the rotational axis (18), or preferably an angle in the range of fifty to seventy degrees to the rotational axis (18).

In the example described above, the aft pivotal axis (41) lies at an angle of approximately eighteen degrees to the rotational axis (18). The aft pivotal axis (41) can lie at a range of angles to the rotational axis (18), for example an angle within the range of zero to forty degrees to the rotational axis (18), or preferably an angle in the range of thirteen to twenty three degrees to the rotational axis (18).

In the example described above, the vehicle included fixed or adjustable handle bars and hand grips. It is envisaged, that in an alternative configuration, the hand engagement means could be supported on levers which are used to alter the angle between aft chassis member and the longitudinal member. For example, the levers could be pivotally mounted on the longitudinal chassis member, and be configured to bear against the aft chassis member to move it relative to the longitudinal chassis member.

Also, in this example described above, the vehicle includes wheels. However it is envisaged that the vehicle could include alternative ground engagement means, for example skis or tracks. And in a further variation, the vehicle could be a water-bourne vehicle having water engagement means, for example hulls or water skis.

In the above example, the self righting means (43) is configured to return the aft chassis member (15) to a neutral or ‘straight ahead’ configuration. It is envisaged that in an alternative configuration, the self righting means (43) could be configured to return the forward chassis member (13) to a neutral or ‘straight ahead’ configuration.

In the above example the forward chassis member (13) comprises a simple rigid axle member with the wheels fitted on bearings at each end. It is envisaged that in an alternative configuration, the forward chassis member (13) could include parts made of a flexible material such as fibreglass to provide some form of simple suspension system, or the vehicle could include a more sophisticated forward suspension system including swing arms, springs and shock absorbers, etc.

In the example described above, the chassis members are framed structures and are made primarily made of metal tubes, for example aluminium or steel tubes. However, it is envisaged that many of the main structural or chassis components could have a monocoque or semi-monocoque construction, and/or could be made of composite materials, for example fibreglass, Kevlar or carbon fibre based composite materials.

### Definitions

Throughout this specification the word “comprise” and variations of that word, such as “comprises” and “comprising”, are not intended to exclude other additives, components, integers or steps.

### Advantages

Thus it can be seen that at least the preferred form of the invention provides a lean steered vehicle that is simple and very light weight. The componentry needed to provide steering are not complex and will not require a great deal of maintenance through the life of the vehicle. And since the vehicle is light in weight, it lends itself to being carried on the towbar of a vehicle using the simple mounting system described above.

And in addition, the pivot points between the longitudinal chassis member and the forward and aft chassis members make suitable points for the vehicle to be dissembled quickly. In this way, the components of the vehicle can be carried within the boot of a car or SUV with relative ease, and re-assembly is quick.

The vehicle is easily manoeuvred and yet it is stable and safe for use on a range of terrain, for example when used on a golf course.

1. A lean steered vehicle, the vehicle having a vehicle chassis, and the vehicle chassis having a forward chassis member, an aft chassis member, and a longitudinal chassis member which is connected to the forward chassis member by a forward pivotal connection which is located at or adjacent a forward end of the longitudinal chassis member, and which is connected to the aft chassis member by an aft pivotal connection which is located at or adjacent an aft end of the longitudinal chassis member, and the longitudinal chassis member is configured to support at least one vehicle occupant, and the angle between the forward chassis member and the longitudinal chassis member, and between the aft chassis member and the longitudinal chassis member, are both controlled by rotating the longitudinal chassis member about a rotational axis.

2. A lean steered vehicle as claimed in claim 1, wherein the rotational axis is an axis which passes substantially through both the forward pivotal connection and the aft pivotal connection.

3. A lean steered vehicle as claimed in claim 1, wherein the forward pivotal connection facilitates rotation about a forward pivotal axis which lies at an angle in the range of thirty to eighty five degrees to the rotational axis.

4. A lean steered vehicle as claimed in claim 3, wherein the forward pivotal connection facilitates rotation about the forward pivotal axis which lies at an angle in the range of fifty to seventy degrees to the rotational axis.

5. A lean steered vehicle as claimed in claim 1, wherein the aft pivotal connection facilitates rotation about an aft pivotal axis which lies at an angle in the range of zero to forty degrees to the rotational axis.

6. A lean steered vehicle as claimed in claim 5, wherein the aft pivotal connection facilitates rotation about the aft pivotal axis which lies at an angle in the range of thirteen to twenty three degrees to the rotational axis.

7. A lean steered vehicle as claimed in claim 1, wherein the rotational axis lies substantially within a vertical plane which is aligned with a longitudinal axis of the vehicle, when the vehicle is situated on level ground.

8. A lean steered vehicle as claimed in claim 1, wherein the rotational axis lies at an angle in the range of ten to thirty degrees to a horizontal plane when the vehicle is situated on level ground.

9. A lean steered vehicle as claimed in claim 1, wherein the vehicle includes a seat and hand engagement means.

10. A lean steered vehicle as claimed in claim 9,
wherein the hand engagement means include handlebars and hand grips.

11. A lean steered vehicle as claimed in claim 9, wherein the hand engagement means are supported by the aft chassis member.

12. A lean steered vehicle as claimed in claim 1, wherein the vehicle includes foot engagement means.

13. A lean steered vehicle as claimed in claim 12, wherein the foot engagement means includes pedals.

14. A lean steered vehicle as claimed in claim 12, wherein the foot engagement means are supported on levers which are used to alter the angle between the forward chassis member and the longitudinal member.

15. A lean steered vehicle as claimed in claim 1, wherein the vehicle includes ground engagement means.

16. A lean steered vehicle as claimed in claim 15, wherein the ground engagement means includes wheels.

17. A lean steered vehicle as claimed in claim 16, wherein the vehicle includes four wheels.

18. A lean steered vehicle as claimed in claim 3, wherein the forward pivotal axis lies within a substantially vertical plane which intersects a longitudinal axis of the vehicle, when the vehicle is situated on level ground and the ground or water engagement means are configured for straight travel.

19. A lean steered vehicle as claimed in claim 1, wherein the vehicle includes self righting means configured to return the aft chassis member and/or the forward chassis member to a neutral or ‘straight ahead’ configuration after any lean steering manoeuvre is used to steer the vehicle to the left or to the right.

20. A lean steered vehicle as claimed in claim 1, wherein the vehicle includes a suspension system between the aft and/or the forward chassis member and the ground or water engagement means.
